(19) United States
(12) Patent Application Publication
(10) Pub. No.: US 2014/0304635 A1
(43) Pub. Date: Oct. 9, 2014

(54) SYSTEM ARCHITECTURE FOR CONTEXTUAL HMI DETECTORS

(71) Applicant: FORD GLOBAL TECHNOLOGIES, LLC, Dearborn, MI (US)

(72) Inventors: Johannes Geir Kristinsson, Ann Arbor, MI (US); Ryan Abraham McGee, Ann Arbor, MI (US); Finn Tseng, Ann Arbor, MI (US); Jeff Allen Greenberg, Ann Arbor, MI (US)

(73) Assignee: FORD GLOBAL TECHNOLOGIES, LLC, Dearborn, MI (US)

(21) Appl. No.: 13/856,041

(22) Filed: Apr. 3, 2013

(51) Int. Cl. G06F 3/0484

(52) U.S. Cl. CPC G06F 3/0484
USPC 715/771

(57) ABSTRACT

A vehicle controller having at least one contextual module configured to receive a sensor input and generate an output representing a driving context. The vehicle controller may have a processor configured to receive the output from the one or more contextual modules. The processor may generate a feature score based on the output and associate the feature score with a selectable option. The processor may select the selectable option with the highest feature score to promote to a user interface device.

### BACKGROUND

A conventional vehicle includes many systems that allow a vehicle user to interact with the vehicle. In particular, conventional vehicles provide a variety of devices and techniques to control and monitor the vehicle's various subsystems and functions. As technology is advancing, more and more features are being introduced to control various subsystems within the vehicle. If there were dedicated hardware controls (e.g., buttons, either on the dashboard or display unit) for all the features available in the vehicle, it may lead to the worst case scenario where there are so many controls that the driver becomes distracted from the main task of driving. Typically, the end user is given no ability to modify or customize the interface to meet their particular means. This may lead to consumer dissatisfaction due to the loss of interface simplicity or poor design.

### SUMMARY

A vehicle controller having at least one contextual module configured to receive a sensor input and generate an output representing a driving context. The vehicle controller may have a processor configured to receive the output from the one or more contextual modules. The processor may then generate a feature score based on the output and associate the feature score with a selectable option. The processor may select the selectable option with the highest feature score to promote to a user interface device.

A system includes a controller configured to receive a sensor input. The controller may generate feature scores based at least in part on the sensor input and may associate the feature score to a plurality of selectable options associated with operation of a vehicle. The controller may be configured to determine an order the plurality of selectable options according to the feature scores associated with each selectable option. The system may include a user interface device configured to display the selectable options in the order determined by the controller. The controller may be configured to continually update the feature score and the order of the plurality of selectable options as the sensor input changes.

A method including generating a feature score, via a computing device, based on a sensor input and associating the feature score with a selectable option. The feature score may represents the likelihood of a vehicle user interacting with the selectable option. The method may further include determining an order in which to display the selectable option on a user interface device based on the associated feature score.

### BRIEF DESCRIPTION OF THE DRAWINGS

FIG. 1A illustrates exemplary components of the user interface system;

FIG. 1B is a block diagram of exemplary components in the user interface system of FIG. 1A;

FIG. 1C is a block diagram of exemplary components in the user interface system of FIG. 1A;

FIG. 2 illustrates a flowchart of an exemplary process that may be implemented by the user interface system.

### DETAILED DESCRIPTION

A vehicle controller having at least one contextual module configured to receive a sensor input and generate an output representing a driving context. The vehicle controller may have a processor configured to receive the output from the one or more contextual modules. The processor may then generate a feature score based on the output and associate the feature score with a selectable option. The processor may select the selectable option with the highest feature score to promote to a user interface device.

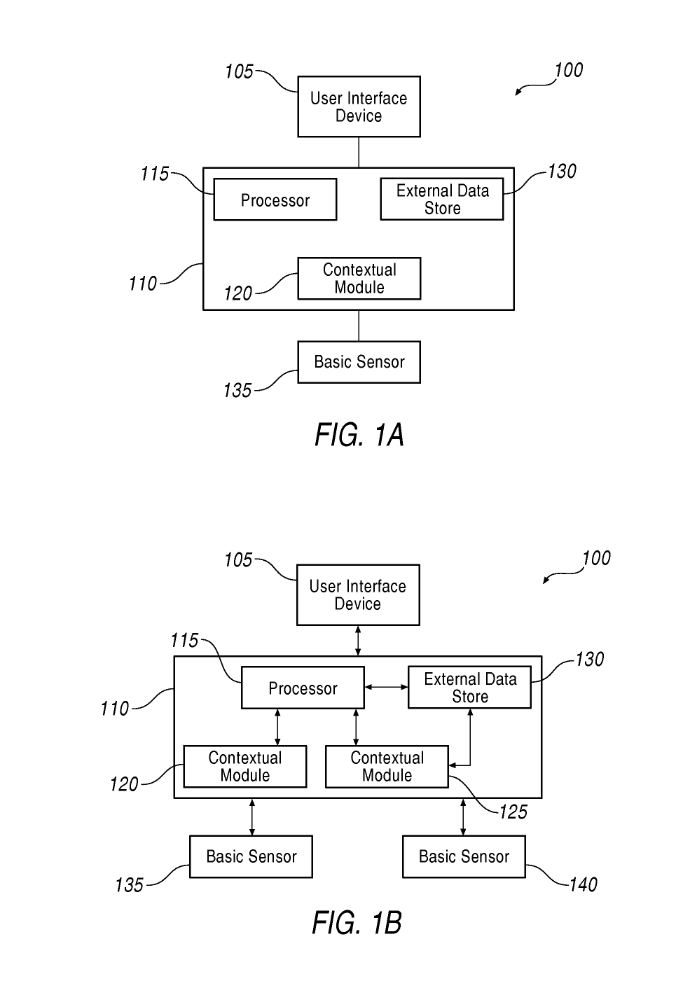

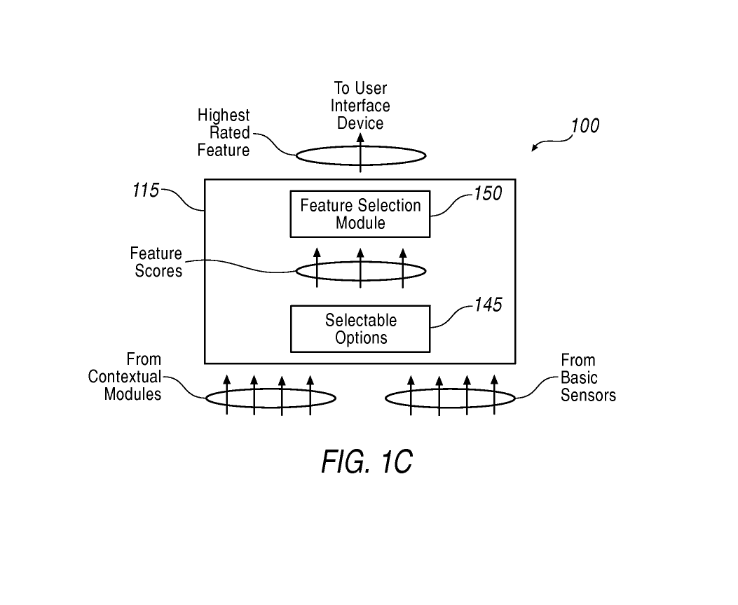

FIG. 1A illustrates an exemplary user interface system. The system may take many different forms and include multiple and/or alternate components and facilities. While an exemplary system is shown in the Figures, the exemplary components illustrated in the Figures are not intended to be limiting. Indeed, additional or alternative components and/or implementations may be used.

FIG. 1A illustrates a diagram of the user interface system 100. While the present embodiment may be used in an automobile, that the user interface system 100 may also be used in any vehicle including, but not limited to, motorbikes, boats, planes, helicopters, off-road vehicles.

With reference to FIGS. 1A and 1B, the system 100 includes a user interface device 105. The user interface device 105 may include a single interface, for example, a single-touch screen, or multiple interfaces. The user interface system 100 may additionally include a single type interface or multiple interface types (e.g., audio and visual) configured for human-machine interaction. The user interface device 105 may be configured to receive user inputs from the vehicle occupants. The user interface device may include, for example, control buttons and/or control buttons displayed on a touchscreen display (e.g., hard buttons and/or soft buttons) which enable the user to enter commands and information for use by the user interface system 100. Inputs provided to the user interface device 105 may be passed to the controller 110 to control various aspects of the vehicle. For example, inputs provided to the user interface device 105 may be used by the controller 110 to monitor the climate in the vehicle, interact with a navigation system, control media playback, or the like. The user interface device may also include a microphone that enables the user to enter commands or other information vocally.

In communication with the user interface device 105 is a controller 110. The controller 110 may include any computing device configured to execute computer-readable instructions that controls the user interface device 105 as discussed herein. For example, the controller 110 may include a processor 115, a contextual module 120, and an external data store 130. The external data store 130 may be include of a flash memory, RAM, EPROM, EEPROM, hard disk drive, or any other memory type or combination thereof. Alternatively, the contextual module 120 and the external data store 130 may be incorporated into the processor. In yet another embodiment, there may be multiple control units in communication with one another, each containing a processor 115, contextual module 120, and external data store 130. The controller 110 may be integrated with, or separate from, the user interface device 105.

In general, computing systems and/or devices, such as the controller 110 and the user interface device 105 may employ any of a number of computer operating systems, including, but by no means limited to, versions and/or varieties of the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OS X and iOS operating system distributed by Apple, Inc. of Cupertino, Calif., the Blackberry OS distributed by Research in Motion of Waterloo, Canada, and the Android operating system developed by the Open Handset Alliance. It will be apparent to those skilled in the art from the disclosure that the precise hardware and software of the user interface device 105 and the controller 110 can be any combination sufficient to carry out the functions of the embodiments discussed herein.

The controller 110 may be configured to control the availability of a feature on the user interface device 105 through the processor 115. The processor 115 may be configured to detect a user input indicating the user's desire to activate a vehicle system or subsystem by detecting the selection of a selectable option on the user interface device 105. A selectable option is created for each feature available in the vehicle (e.g., temperature control, heated seats, parking assists, cruise control, etc.). Accordingly, there may be one selectable option associated with a particular vehicle feature. Each selectable option may control a vehicle system or subsystem. For example, the selectable option for cruise control will control the vehicle system monitoring the vehicle's constant speed (or cruise control).

The controller 110, via the processor 115, may be configured to determine the features most likely to be of use to the driver or passenger, and eliminate the features that have minimal or no use to the driver/passenger, given the particular driving context. In order to determine the feature that may have the most relevance, the controller 110 may receive input from contextual variables communicated by the contextual module 120 and basic sensors 135 via an interface. The interfaces may include an input/output system configured to transmit and receive data from the respective components. The interface may be one-directional such that data may only be transmitted in one-direction. Additionally, the interface may be bi-directional, both receiving and transmitting data between the components.

The controller may include many contextual modules 120, each configured to output a specific context or contextual variable. For example, one contextual module 120 may be configured to determine the distance to a known location. Another contextual module 120 may be configured to determine the vehicle's speed in relation to the current speed limit. Yet another contextual module may be configured to determine whether the vehicle has entered a new jurisdiction requiring different driving laws (e.g., a “hands-free” driving zone). In an exemplary illustration, each output may be received by each of the many selectable options, and may be used and reused by the selectable options to produce a feature score. That is, each of the many contextual modules 120 always performs the same operation. For example, the contextual module 120 for vehicle's speed in relation to current speed limit will always output that context, although the context may be received by different selectable options.

A contextual variable may represent a particular driving condition or context, for example, the vehicle's speed, location, traffic condition, or lighting condition. The contextual variables may be output from the contextual module 120 or the basic sensor 135. The controller 110 may be configured to select a feature with a high likelihood of vehicle user interaction based on the input received from the contextual module 120 and basic sensors 135. In one exemplary approach, each feature available on the user interface device 105 is represented by one particular selectable option. For example, the feature for a garage door opener may be always associated with a selectable option for the garage door opener.

In one possible implementation, the contextual variables may represent a numerical value depending on the driving context. Additionally or alternatively, the contextual variables may represent a particular context, such as outside temperature, precipitation, or distance to a specific establishment. For example, the contextual variable output may indicate the vehicle is approaching an establishment that offers valet services. There may be two types of contextual variables: simple contextual variables and smart contextual variables. Simple contextual variables may be derived from the basic sensor 135. A basic sensor 135 may include any sensor or sensor systems available on the vehicle. For example, the basic sensor 135 could embody audio sensors, light sensors, accelerometers, velocity sensors, temperature sensors, navigation sensors (such as a Global Positioning System sensor), etc. Smart contextual variables may be output by the contextual module 120 and may represent other contextual variables aggregated into values which are not readily available in the vehicle. That is, no other system or subsystem within the vehicle can generate a smart contextual variable alone. For example, in order to produce the smart contextual variables, the contextual module 120 may receive inputs from either simple contextual variables output by the basic sensors 135 or other smart contextual variables output by contextual modules 120 and aggregate these outputs into complex values (e.g., aggregations of multiple values). There may be various ways in which the contextual module may produce their values. For example, techniques may involve Fuzzy Logic, Neural Networks, Statistics, Frequentist Inference, etc.

The controller 110 may include a database, such as an external data store 130, either located within the controller 110 or as a separate component. Alternatively, the external data store 130 may be in communication with the controller 110 through a network, such as, for example, cloud computing over the Internet. The processor 115 may be configured to communicate with the external data store 130 whenever saved information is needed to assist in generating a selectable option. The external data store 130 may communicate with the contextual module 125 to produce a smart contextual variable. Likewise, the external data store 130 may communicate directly with the processor 115.

The external data store 130 may be composed of general information such as a navigation database which may, for example, retain street and jurisdiction specific laws, or user specific information such as the preferred inside temperature of the vehicle. Likewise, the navigation database may include points-of-interest which may represent, for example, whether a particular service is offered by an establishment (either by inference through interpretation of the name of the point of interest or directly obtaining the information through an on-board map database) or the users preference (e.g., Tuscan style cuisine). Additionally or alternatively, the external data store 130 may track vehicle feature activations at specific locations or under particular driving contexts. For example, if a feature, such as cruise control, is regularly activated on a specific highway or street, the external data store 130 may communicate this information to a contextual module 120, 125, which may ultimately help produce a higher feature score for cruise control. Further, the external data store 130 may be updated using, for example, telematics or by any other suitable technique. A telematics system located within the vehicle may be configured to receive updates from a server or other suitable source (e.g., vehicle dealership). Likewise, the external data store 130 may be updated manually with information, such as user preferences, input by the vehicle user on the user interface device 105. For example, the user may indicate a preference of using a particular feature at a particular establishment. The user preference may be communicated to a contextual module 120 and factor into the score output by the contextual module (e.g., increase or decrease the value feature score associated with the selectable option). Furthermore, the controller 110 may be configured to enable the user interface system 100 to communicate with a mobile device through a wireless network. Such a network may include a wireless telephone, Bluetooth®, personal data assistant, 3G and 4G broadband devices, etc.

The processor 115 may be configured to detect inputs, such as the contextual variables, communicated by the contextual module 120. The processor 115 may store each selectable option associated with a specific feature available for use by the user interface device 105. The processor 115 receives input from a range of contextual variables generated from a basic sensor 135 and the contextual module 120 and attributes the inputs to the available selectable options. That is to say, every selectable option receives input from the basic sensors 135 and contextual modules 120 at all times. The processor 115 aggregates the variables attributed to each selectable option to generate a feature score which may indicate the likelihood the particular feature will be interacted with by the user. Each selectable option is associated with a feature score. However, depending on the driving conditions and context, the feature scores associated with the selectable options may differ. Many implementations may be used to aggregate the contextual variables, such as, but not limited to, taking the product, summation, average, or non-linear algorithms such as fuzzy logic, for example. In one embodiment, the processor 115 associates a feature score of 0 to 1 with the selectable option, in which 0 may represent the feature is unlikely to be selected at the moment and 1 represents that the user has the highest likelihood of wanting to use the feature. Thus, a feature already in use (e.g., the vehicle system or subsystem is currently in use) would score low on the decimal system because there is no likelihood of future interaction with the feature. However, this preference may be altered by the driver or manufacture so that 1 represents that the user is actively interacting with the feature. Further, the decimal score range is illustrative only and a different range of numbers could be used if desired.

After the processor 115 generates a feature score, the processor 115 may output the feature score to the user interface device 105 for display. Based on the preference of the driver or manufacturer, the processor 115 may select the selectable option with the highest feature score to display on the user interface device 105. The highest feature score may represent the preferred selectable option or feature at the particular moment. In an alternative embodiment, the processor 115 may rank the selectable options based on their feature scores and select multiple features with the highest feature scores to be displayed on the user interface device 105.

FIG. 1B illustrates a general system interaction of an embodiment of the user interface system 100. Initially, the basic sensors 135 and 140 collect information from sensors or sensor systems available on the vehicle and output simple contextual variables. For example, the basic sensor could represent the current outside temperature or vehicle GPS location. The contextual modules 120 and 125 may receive simple contextual variables, other smart contextual variables, and/or information from the external data store 130 to produce smart contextual variables. The processor 115 may receive both the smart contextual variables and simple contextual variables to ascribe their values to multiple selectable options. The selectable options are each associated with a feature score that is generated from the output of the contextual variable received. For example, if the contextual variables communicate that the vehicle is driving on a highway close to the speed limit, the selectable option for the feature cruise control will produce a high score, whereas the selectable option for the features for heated seats or garage door opener will produce a low feature score.

The processor 115 may rank the selectable options according to their associated feature score. The processor 115 may select the highest scoring selectable option. Depending on how the user interface system 100 is configured, the processor 115 may either promote the selectable option with the highest feature score or promote multiple selectable options to the user interface device 105. At the same time, the processor 115 may eliminate a feature(s) from the user interface device 105 that no longer has a high likelihood of user interaction. The basic sensors 135, 140, and contextual modules 120, 125 are active at all times to facilitate the production of a continuous feature score for each selectable option. The processor 115 uses these scores to provide the most current driving contexts to the user interface device 105 so that the selectable option with the highest feature score is always displayed on the user interface device 105.

FIG. 1C is an exemplary illustration of a processor 115 of the user interface system 100. The processor 115 may include all of the selectable options 145 associated with the available vehicle features as well as a feature selection module 150. The feature selection module 150 may be any device that provides computer-executable instructions such as receiving and analyzing feature scores, for example. Additionally or alternatively, the processor 115 may further include the contextual modules, as previously indicated.

In an exemplary illustration, the processor 115 may receive input from multiple contextual modules 120 and basic sensors 135. The input (e.g., simple and smart contextual variables) may be attributed to the various selectable options 145 to be aggregated together in order to produce a feature score. For example, each of the selectable options 145 receives input from one or more contextual modules and basic sensors. Each of the multiple selectable options 145 produces a feature score based on the contextual module and basic sensor input. The feature selection module 150 may receive the various feature scores and choose the selectable option with the highest associated feature score. The processor 115, via the feature selection module 150, may then output the feature with the highest feature score to be displayed on the user interface device 105.

An illustrative example of the general user interface system 100 will now be provided for an embodiment where the selectable option is for cruise control. In this exemplary illustration, a basic sensor 135 may output vehicle speed as a simple contextual variable, while another basic sensor 140 may output current position as its simple contextual variable. The vehicle's current position (by way of GPS, for example) may be communicated to a contextual module 120, and together with an external data store 130 (e.g., a navigation database which has stored the posted speed limits of each street), generate the smart contextual variable of speed limit (e.g., vehicle position combined with map database providing posted speed limits). The simple contextual variable vehicle speed and the smart contextual variable current speed limit may be communicated to a second contextual module 125 to generate the smart contextual variable of relative current speed to the current speed limit. This smart contextual variable may be communicated to the processor 115 to be attributed to the selectable options.

The processor 115 may generate a feature score for each selectable option relative to the particular driving context. The feature score for the cruise control selectable option, for example, may depend on how close the vehicle is driving to the speed limit. The cruise control selectable option may have a high feature score when the user is driving close to the speed limit and nothing else, barring unusual circumstances, would prevent the user from driving slower (e.g., the vehicle is driving on a highway or in an area with few intersections, traffic and weather conditions support driving at the speed limit, etc.). On the other hand, the feature score for garage door opener, for example, may generate a low feature score under the same conditions. The processor 115 may select the cruise control selectable option based on its feature score and promote it to be displayed on the user interface device 105 when the feature score becomes higher than the feature scores of other selectable options. A selectable option with a lesser feature score may be simultaneously demoted or removed from the user interface device 105.

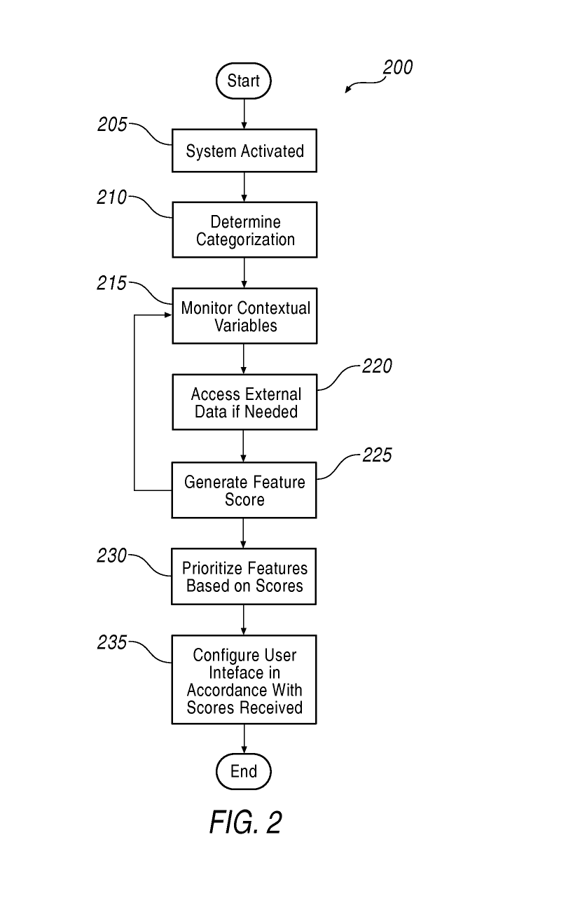

FIG. 2 illustrates a flowchart of an exemplary process 200 that may be implemented by the user interface system 100. The operation of the user interface system 100 may activate (block 205) automatically no later than when the vehicle's ignition is started. At this point, the vehicle may go through an internal system check in which the operational status of one or more vehicle systems and/or subsystems will be determined in order to ensure that the vehicle is ready for operation. While the internal system check is being verified, the system 100 may additionally determine the categorization of the selectable options available in the vehicle at block 210. The system 100 may categorize the available features (and their corresponding selectable options) of the user interface system 100 into a departure group and an arrival group, for example. The departure category may include features commonly used when leaving a location, for example a garage door opener or climate control. The arrival category may include features commonly used when in route to or arriving at a destination, for example cruise control or parking assistance. The categorization process may be performed by the controller 110. The separation of features may either be preset by the vehicle manufacturer or dealership, or the vehicle owner may customize the departure group and arrival group based on their preference. Separating the features into two or more groups may help reduce processing time in the later stages by limiting the number of features available for selection.

At block 215, the system 100 may begin monitoring the contextual variables produced by the basic sensors 135 and the contextual modules 120. As previously mentioned, the contextual variables may be either simple contextual variables which are derived directly from sensors available in the vehicle, or smart contextual variables derived from aggregations of other contextual variables (whether simple or smart) into values or contexts not readily available in the vehicle. The system 100 may further check whether additional external information is needed at block 220 from the external data store 130. This may occur where the contextual variables require stored information, such as street speed limits or cabin temperature preference of the vehicle user. If additional external information is need, the information may be communicated to the contextual modules 120 to assist in generating a smart contextual variable. If additional external information is not need, or has already been provided and no more information is needed, the process 200 may continue at block 225.

At block 225, the contextual variables may be communicated to the processor 115 to generate a feature score. The processor 115 may combine the inputs received and associate the values to each selectable option available within the vehicle to produce the feature score. The feature scores may be generated by aggregating the contextual variables by taking the product, average, maximum, minimum, or other non-linear algorithms such as fuzzy logic or neural networks, for example. The feature score may be directly proportional to the relevance of the aggregation of the contextual variables communicated to the processor 115. For example, when the contextual variables indicate that a vehicle is driving on a highway, has a relative speed close to the speed limit, but notices the vehicle is varying speeds above and below the speed limit (e.g., as in the case of heavy traffic), the feature score for the cruise control selectable option will have a lesser value compared to when the vehicle is traveling at a constant speed, near the speed limit, for a period of time. Furthermore, the same variables attributed to the parking assist selectable option, for example, may have a very low feature score because the likelihood of parking while traveling at high speeds is very low.

At block 230, the processor 115 may prioritize the selectable options based on their associated feature scores. Generally, the selectable options with the highest feature score may have the highest priority, and the rest of the available selectable options are ranked accordingly thereon. Depending on the user preference, either the feature with the highest feature score, or multiple features (e.g., the three features with the highest feature scores), may be promoted to the user interface device 105 at step 235 for display and performance. Likewise, the features already displayed on the user interface device 105 may be simultaneously eliminated (or demoted) if their relevance within the particular driving context has decreased. Additionally or alternatively, the processor 115 or controller 110 may order the selectable options according to the feature score associated with each selectable option. The controller 110 may then determine the order of the selectable options with feature scores above a predetermined threshold. For example, the controller 110 may only select the selectable options with a feature score at or above 0.7. The controller 110 may then rank the available selectable options with the highest feature score to a first position in the order, and another selectable option with a slightly lower feature score to a second position in the order, and so on.

As shown, blocks 215 to 225 perform a continuous cycle while the vehicle is in operation. The basic sensors 135 and contextual modules 120 are active at all times, continually inputting information into the processor which continuously generates new feature scores associated with available selectable options. Accordingly, the processor 115 updates the priority rankings at block 230 so the most relevant features (or selectable options) will be presented at all times on the user interface device 105 at block 235.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, the use of the words “first,” “second,” etc. may be interchangeable.

1. A vehicle controller comprising:
at least one contextual module configured to receive a sensor input and generate an output representing a driving context; and
a processor configured to receive the output from the one or more contextual modules, generate a feature score based on the output, associate the feature score with a selectable option, and select the selectable option with the highest feature score to promote to a user interface device.

2. The vehicle controller of claim 1, wherein the processor is configured to prioritize the selectable options in an order according to the feature score associated with each selectable option.

3. The vehicle controller of claim 2, wherein the processor is further configured to determine the order of the selectable options with feature scores above a predetermined threshold.

4. The vehicle controller of claim 3, wherein the processor is configured to continually update the feature score and the order of the selectable options as the sensor input changes.

5. The vehicle controller of claim 1, wherein the feature score represents a likelihood that a user will interact with a selectable option.

6. The vehicle controller of claim 1, wherein the contextual module is configured to receive a signal from another contextual module and generate a signal representing the aggregation of the sensor input and the signal from the other contextual module.

7. The vehicle controller of claim 1, wherein the contextual module may access an external data store.

8. A system comprising:
a controller configured to receive a sensor input, generate feature scores based at least in part on the sensor input, and associate the feature scores to a plurality of selectable option associated with operation of a vehicle, wherein the controller is configured to determine an order of the plurality of selectable options according to the feature scores associated with each selectable option; and
a user interface device configured to display the selectable options in the order determined by the controller, wherein the controller is configured to continually update the feature scores and the order of the plurality of selectable options as the sensor input changes.

9. The system of claim 8, wherein the feature score represents a likelihood that a user will interact with the selectable option.

10. The system of claim 8, wherein the controller is configured to determine which selectable option has the highest feature score and prioritize the selectable options based on the associated feature score, wherein the highest feature score will have the highest priority.

11. The system of claim 8, wherein each of the selectable options corresponds to a feature to be displayed on the user interface device, wherein the selectable option performs a system operation on the vehicle.

12. The system of claim 8, wherein the controller is further configured to determine the order of the selectable options with feature scores above a predetermined threshold.

13. The system of claim 8, wherein the controller includes a plurality of contextual modules, wherein at least one of the contextual modules is configured to receive the sensor input.

14. The system of claim 13, wherein at least one of the contextual modules is configured to receive a signal from at least another contextual module and generate a signal representing an aggregation of the sensor input and the signal from the other contextual module.

15. A method comprising:
generating, via a computing device, a feature score based on a sensor input and associating the feature score with a selectable option, wherein the feature score represents a likelihood of a vehicle user interacting with the selectable option; and
determining an order in which to display the selectable option on a user interface device based on the associated feature score.

16. The method of claim 15, further comprising continually updating the feature score and the selectable option as the sensor input changes.

17. The method of claim 15, further comprising communicating the sensor input to a contextual module.

18. The method of claim 15, further comprising categorizing selectable options to be associated with a departure group and an arrival group.

19. The method of claim 17, wherein the contextual module receives an input from an external data store.

20. The method of claim 15, further comprising prioritizing the selectable options based on the associated feature score, wherein the highest feature score will have the highest priority.
